(19) United States
(12) Patent Application Publication
(10) Pub. No.: US 2016/0026237 A1
(43) Pub. Date: Jan. 28, 2016

(54) SCREEN CHANGING DEVICE, SCREEN CHANGING METHOD, AND SCREEN CHANGING PROGRAM

(71) Applicant: NEC SOLUTION INNOVATORS, LTD., Tokyo (JP)

(72) Inventor: Masakazu MORIGUCHI, Tokyo (JP)

(73) Assignee: NEC Solution Innovators, Ltd., Tokyo (JP)

(21) Appl. No.: 14/761,095

(22) PCT Filed: Dec. 25, 2013
(86) PCT No.: PCT/JP2013/007576

§ 371 Date: Jul. 15, 2015

(30) Foreign Application Priority Data
Jan. 21, 2013 (JP) 2013-008110

(51) Int. Cl. G06F 3/01

(52) U.S. Cl. CPC G06F 3/011; G06F 2203/011

(57) ABSTRACT

A screen changing device includes: an operation log organization unit 21 for organizing operation logs containing operation contents on operation screens by type; an emotion storage unit 26 for storing user's emotions and emotion quotients indicating magnitudes of the emotions corresponding to the operation logs; an emotion allocation unit 22 for allocating the user's emotions and the emotion quotients stored in the emotion storage unit to the organized operation logs; a display unit 25 for displaying the information on the user's emotions and the emotion quotients allocated to the operation logs; an improvement idea storage unit 30 for storing improvement ideas of the operation screens corresponding to user's emotions; a screen improvement unit 28 for acquiring the improvement ideas of the operation screens corresponding to the user's emotions allocated to the operation logs from the improvement idea storage unit and presenting the same on the display unit; and a screen changing unit 29 for changing the operation screen based on an improvement idea selected by a designer from among the presented improvement ideas.

TECHNICAL FIELD

The present invention relates to a screen changing device for changing to an operation screen comfortable for a user using the operation screen, a screen changing method, and a screen changing program.

### BACKGROUND ART

In some cases, a user may not comfortably utilize a system because he/she does not know the functions or the meanings of terms for an operation screen of the system, many items of unnecessary information are present, necessary information is not present, many useless operations are required, or the like. In such a case, the user asks someone how to use the system or uses the manual. However, there are problems such as interruption of a work while asking how to use and an increase in steps of creating a manual. Further, a user may become accustomed by continuously using the operation screen, but productivity is low until he/she becomes accustomed, and he/she may forget without use of it.

Further, a system designer improves the operation screen by taking measures such as taking user tests, interviewing users or being supported by an expert. When a user test is taken, however, there are problems such as increase in steps of the test and responses to various personas. Further, when an interview is made to the user, a potential problem cannot be clarified, and there arises a problem such as biased opinion due to subjective aspect of the user to be interviewed. When a support is made by an expert, there are problems such as deterioration in cost performance and he/she uses heuristic principle mainly.

As a method for solving the problems, Patent Literature 1 discloses therein a technique for acquiring operation contents performed on a WEB screen, and accumulating and counting, based on the operation contents, per evaluation item such as the number of times of erroneous clicks on positions other than components to be operated, the number of times of clicks in an erroneous order, a pointer movement trajectory length, or the amount of screen scrolling, thereby correcting the WEB screen.

Non-Patent Literature 1 further describes that emotions are not independent of each other but have certain correlations.

### CITATION LIST

### Patent Literature

PLT 1: JP 2004-252872 A

### Non Patent Literature

NPL 1: Robert Plutchik, “The Nature of Emotions”, American Scientist, Volume 89, p 344-p 350

### SUMMARY OF INVENTION

### Technical Problem

With the technique disclosed in Patent Literature 1, however, an evaluation is made per evaluation item, but comfort for a user is not expressed. Therefore, it is difficult for the designer to change to an operation screen comfortable for the user.

It is therefore an object of the present invention to provide a screen changing device capable of changing an operation screen of a system to an operation screen comfortable for a user, a screen changing method, and a screen changing program.

### Solution to Problem

A screen changing device of the present invention includes: an operation log organization unit for organizing operation logs containing operation contents on operation screens by type; an emotion storage unit for storing user's emotions and emotion quotients indicating magnitudes of the emotions corresponding to the operation logs; an emotion allocation unit for allocating the user's emotions and the emotion quotients stored in the emotion storage unit to the organized operation logs; a display unit for displaying the information on the user's emotions and the emotion quotients allocated to the operation logs; an improvement idea storage unit for storing improvement ideas of the operation screens corresponding to user's emotions; a screen improvement unit for acquiring the improvement ideas of the operation screens corresponding to the user's emotions allocated to the operation logs from the improvement idea storage unit and presenting the same on the display unit; and a screen changing unit for changing the operation screen based on an improvement idea selected by a designer from among the presented improvement ideas.

A screen changing method of the present invention includes the steps of: organizing operation logs containing operation contents on operation screens by type; storing user's emotions and emotion quotients indicating magnitudes of the emotions corresponding to the operation logs; allocating the stored user's emotions and emotion quotients to the organized operation logs; displaying the information on the user's emotions and the emotion quotients allocated to the operation logs; storing improvement ideas of the operation screens corresponding to user's emotions; acquiring and presenting the stored improvement ideas of the operation screens corresponding to the user's emotions allocated to the operation logs; and changing the operation screen based on an improvement idea selected by a designer from among the presented improvement ideas.

A screen changing program of the present invention causes a computer to perform: an operation log organization processing of organizing operation logs containing operation contents on operation screens by type; an emotion storage processing of storing user's emotions and emotion quotients indicating magnitudes of the emotions corresponding to the operation logs; an emotion allocation processing of allocating the user's emotions and the emotion quotients stored in the emotion storage processing to the organized operation logs; a display processing of displaying the information on the user's emotions and the emotion quotients allocated to the operation logs; an improvement idea storage processing of storing improvement ideas of the operation screens corresponding to user's emotions; a screen improvement processing of acquiring and presenting the stored improvement ideas of the operation screens corresponding to the user's emotions allocated to the operation logs; and a screen changing processing of changing the operation screen based on an improvement idea selected by a designer from among the presented improvement ideas.

According to the present invention, it is possible to change an operation screen of a system to an operation screen comfortable for a user.

### BRIEF DESCRIPTION OF DRAWINGS

FIG. 1 It depicts a block diagram illustrating a structure of a screen changing device according to an exemplary embodiment of the present invention.

FIG. 2 It depicts a flowchart illustrating the operations of the screen changing device according to the exemplary embodiment of the present invention.

FIG. 3 It depicts an explanatory diagram illustrating an exemplary operation screen.

FIG. 4 It depicts an explanatory diagram illustrating screen display expressing emotion quotients by use of a heat map.

FIG. 5 It depicts an explanatory diagram illustrating screen display displaying evaluation contents and a question about whether to change an operation screen together with emotion quotients.

FIG. 6 It depicts an explanatory diagram illustrating screen display displaying a process map together with emotion quotients.

FIG. 7 It depicts an explanatory diagram illustrating screen display expressing emotion quotients by use of a timeline.

FIG. 8 It depicts an explanatory diagram illustrating an exemplary screen indicating an emotion quotient per block.

FIG. 9 It depicts an explanatory diagram illustrating an exemplary table of emotions.

FIG. 10 It depicts an explanatory diagram illustrating an exemplary table of types to be improved.

FIG. 11 It depicts an explanatory diagram illustrating an exemplary table of improvement ideas.

FIG. 12 It depicts an explanatory diagram illustrating an exemplary improved operation screen.

FIG. 13 It depicts a block diagram illustrating a structure of essential parts in a screen changing device according to the present invention.

### DESCRIPTION OF EMBODIMENTS

An exemplary embodiment of the present invention will be described below with reference to the drawings.

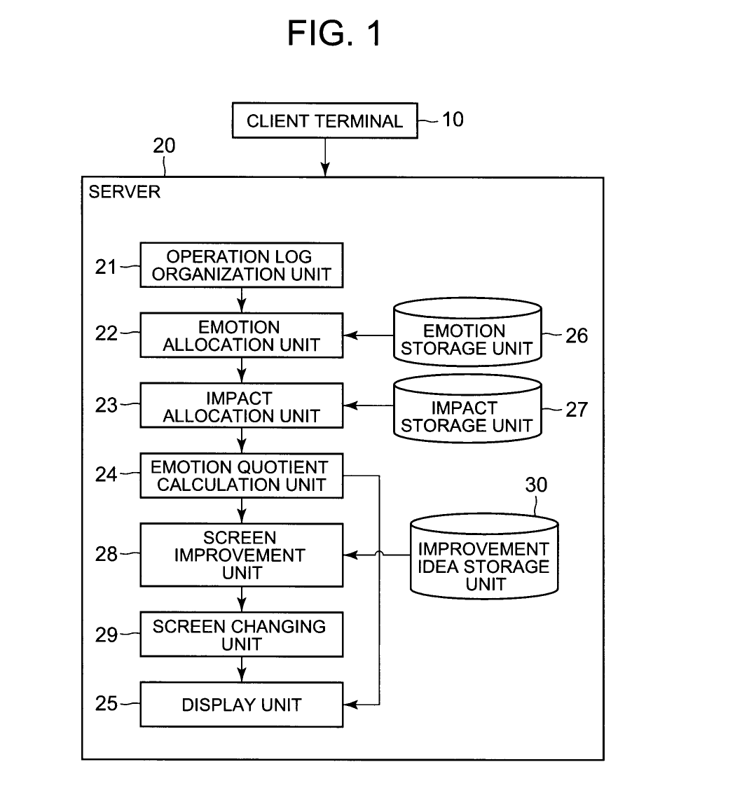

FIG. 1 is a block diagram illustrating a structure of a screen changing device according to the present exemplary embodiment. The screen changing device according to the present exemplary embodiment is realized by a server 20 illustrated in FIG. 1. The server 20 is connected with a client terminal 10 used by a user via a communication line such as Internet line or LAN (Local Area Network) line.

The server 20 includes an operation log organization unit 21, an emotion allocation unit 22, an impact allocation unit 23, an emotion quotient calculation unit 24, a display unit 25, an emotion storage unit 26, an impact storage unit 27, a screen improvement unit 28, a screen changing unit 29, and an improvement idea storage unit 30.

The operation log organization unit 21, the emotion allocation unit 22, the impact allocation unit 23, the emotion quotient calculation unit 24, the impact storage unit 27, the screen improvement unit 28, and the screen changing unit 29 are realized by an information processing apparatus such as CPU (Central Processing Unit) operating according to a program. Further, the emotion storage unit 26 and the impact storage unit 27 are stored in a storage device such as ROM (Read Only Memory), RAM (Random Access Memory), or hard disk. The emotion storage unit 26, the impact storage unit 27, and the improvement idea storage unit 30 are storage devices including typical databases or text files, for example. The display unit 25 is a CRT (cathode-ray tube) or liquid crystal display, for example.

The client terminal 10 displays operation screens for WEB sites or client server type applications. When the user operates an operation screen displayed on the client terminal 10, an operation log is transmitted from the client terminal 10 to the server 20. The operation log contains user's operation contents on the operation screen, time information on operations, user information, information on screen contents and screen transition, and the like.

The operation log organization unit 21 organizes the operation logs by type of the operation contents transmitted from the user. Specifically, the operation log organization unit 21 counts the number of times by type of the operation contents, and organizes the number of times, probabilities, and the like of the performed operation contents.

The emotion allocation unit 22 allocates an emotion to a user's operation log. The emotion storage unit 26 is previously allocated with an emotion and an emotion quotient indicating a magnitude of the emotion corresponding to an assumed operation log. The emotion allocation unit 22 allocates an emotion and an emotion quotient to an acquired operation log by use of data in the emotion storage unit 26.

The impact allocation unit 23 allocates an impact to an operation log transmitted by the user. The impact storage unit 27 stores therein an impact on a user's emotion of an operation log. The impact allocation unit 23 allocates an impact to an acquired operation log based on data in the impact storage unit 27.

The emotion quotient calculation unit 24 calculates an emotion quotient in consideration of an impact. An emotion quotient in consideration of an impact is calculated by a calculation equation of emotion quotient×impact, for example.

Further, the emotion quotient calculation unit 24 integrates user's emotion quotients by a predetermined unit. The emotion quotient calculation unit 24 integrates emotion quotients by the coordinate indicating a position on an operation screen, for example. When integrating emotion quotients by the coordinate, the emotion quotient calculation unit 24 adds a newly-calculated emotion quotient to the emotion quotients already calculated for a coordinate. A unit to integrate emotion quotients is not limited to coordinate, and may be screen, screen transition, or the like. Further, the emotion quotient calculation unit 24 may integrate the emotion quotients integrated by the above unit by a predetermined period unit such as by the day of the week or by the hour.

Further, the emotion quotient calculation unit 24 replaces an emotion quotient of an emotion with an emotion quotient of other emotion based on predefined numerical values indicating correlations of emotions. When a negative quotient is to be displayed as an emotion quotient after an emotion quotient of anger for an operation log is calculated, for example, the emotion quotient calculation unit 24 replaces the emotion quotient of anger with the negative quotient by use of a correlation of the anger quotient relative to the negative quotient.

When requested by the manger, the display unit 25 displays a user's emotion according to an emotion quotient. The display unit 25 displays the emotion quotients by different colors, for example. The emotion quotient display method may employ display methods such as heat map, process map and timeline. Further, when the emotion quotient calculation unit 24 determines that the negative quotient is higher than a predetermined value, the display unit 25 displays a question about whether to change the screen. When the screen is changed, the display unit 25 displays the screen changed by the screen changing unit 29.

The improvement idea storage unit 30 stores improvement ideas of the operation screens corresponding to user's emotions. Specifically, the improvement idea storage unit 30 stores therein user's emotions before improvement when the operation screen was changed in the past, types to be improved corresponding to emotions, improvement ideas, and reasons to employ improvement ideas in an associated manner.

The screen improvement unit 28 acquires emotion quotients of the operation screens from the emotion quotient calculation unit 24. The operation screen contains a plurality of blocks, and each block contains a plurality of coordinates. The screen improvement unit 28 assumes an average value of emotion quotients at the respective coordinates as an emotion quotient of the block. Further, when a plurality of emotions are present in one block, the screen improvement unit 28 applies an improvement idea corresponding to an emotion with the highest rate in the block.

Further, the screen improvement unit 28 acquires a type to be improved according to an emotion quotient of the block. When the designer instructs to change the screen or when the emotion of the block is a negative emotion such as anger and negative and its emotion quotient is higher than a predetermined value, the screen improvement unit 28 acquires a type to be improved corresponding to the emotion by use of a table of types to be improved stored in the improvement idea storage unit 30. Specifically, the screen improvement unit 28 presents the types to be improved from the table of types to be improved stored in the improvement idea storage unit 30, and acquires a type to be improved selected by the designer. The display unit 25 is used for the presentation, for example.

Further, the screen improvement unit 28 acquires an improvement idea corresponding to the selected type to be improved from the table of improvement ideas. Specifically, the screen improvement unit 28 presents the improvement idea corresponding to the selected type to be improved and the reason why the improvement idea is employed, and acquires the improvement idea selected by the designer. The display unit 25 is used for the presentation, for example.

The screen changing unit 29 changes the operation screen based on the selected improvement idea. Further, the screen changing unit 29 causes the display unit 25 to display the changed screen.

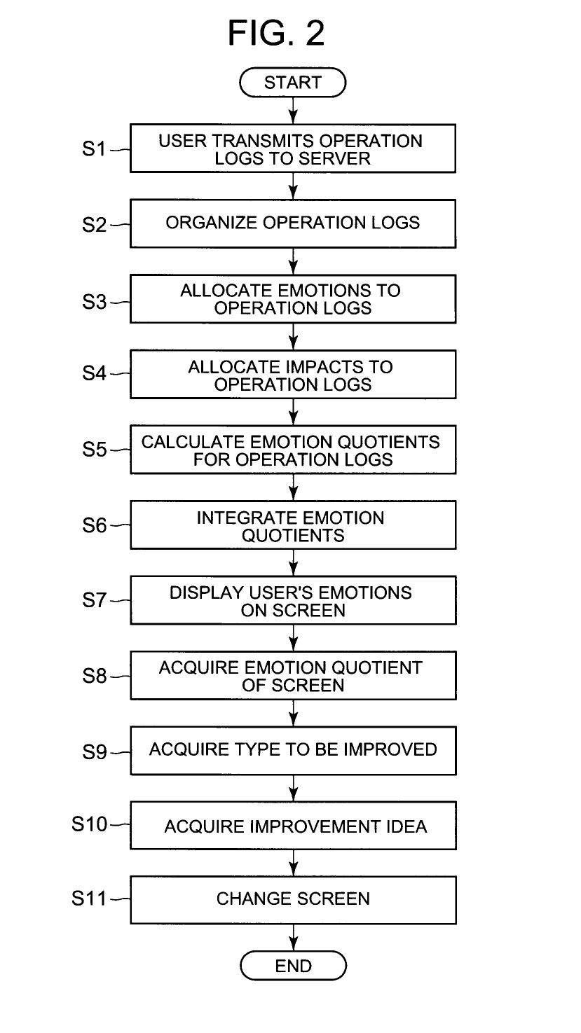

The operations of the screen changing device according to the present exemplary embodiment will be described below. FIG. 2 is a flowchart illustrating the operations of the screen changing device according to the present exemplary embodiment.

The client terminal 10 transmits, to the server, an operation log containing user's operation contents on an operation screen, time information on operations, user information, screen contents, and information on screen transition according to a user's operation (step S1). Specifically, the client terminal 10 collects the operation logs together at a timing of a specific operation and transmits the same to the server 20. Alternatively, the client terminal 10 may perform a real-time processing of transmitting operation logs per single operation. Alternatively, the client terminal 10 may collect operation logs at predetermined time intervals and transmit the same to the server.

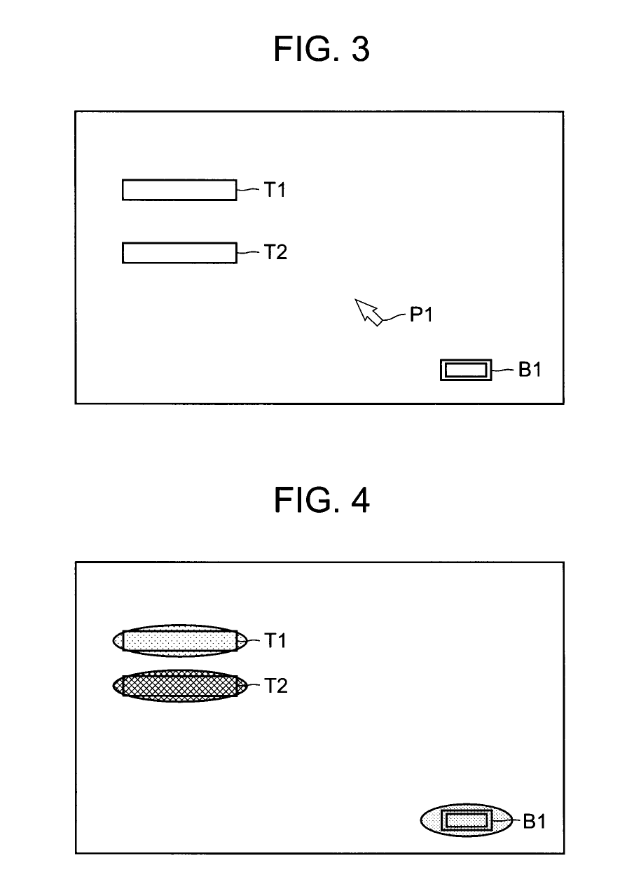

FIG. 3 is an explanatory diagram illustrating an exemplary operation screen. In the example illustrated in FIG. 3, text boxes T1 and T2, a pointer P1, and a button B1 are displayed on the operation screen. The operation screen may include a pull-down or scroll bar, for example, not limited to those illustrated in FIG. 3.

The user's operation contents are an operation of inputting characters in a text box, an operation of pressing the button, a scroll operation, moving a pointer, and the like. For example, for the operation of inputting characters in a text box, the input characters are recorded in an operation log. For example, for the operation of pressing the button and the scroll operation, the number of times of operations is recorded. For example, for moving the pointer, a pointer movement trajectory is recorded as an operation log.

The time information contained in the operation log indicates information on a time when an operation is performed or a time interval between an operation and other operation, for example. For example, when the button is pressed a predetermined time after a character is input in a text box, the time therefor is recorded in the operation log. Not only the operation contents but also the time information on operations is recorded in the operation log, and thus the designer can easily know user's emotions such as indecision and confusion. For example, if the OK button is blind without screen scrolling, a user's operation movement trajectory travels on the screen, and the OK button is pressed over time, the user is regarded indecisive.

The user information contains user ID, IP address, and the like, for example. Further, the screen contents contain label of pressed button, coordinate of button, arrangement of other objects for user's operations.

The user-operated screen is an operation screen for Web site or client server type application, for example, but any other operation screen displayed according to a typical program may be employed. The user's operations are not only operations via the mouse or keyboard but also gesture or speech recognition, for example. One or more users are possible, and for a plurality of users, the operation logs of the users are asynchronously transmitted.

The operation log organization unit 21 then organizes the operation logs transmitted by the user by type of the operation contents (step S2). Specifically, the operation log organization unit 21 counts the number of times by type of the operation contents, and calculates and organizes the number of times, probabilities, and the like of the performed operation contents. For example, assuming that the number of times of screen display is 200 and the number of times of input into a text box is 100, the probability is assumed as 100÷200=50%.

Further, the operation log organization unit 21 organizes the number of times, probabilities, and the like similarly for the operation contents in a combination of operations such as “input into text box, then press button”, not only the information on each of the operation contents. When such an operation in combination of operations is performed, the operation log organization unit 21 counts a time between the operations, and calculates an average value, a maximum value, and the like. If the user does nothing, the number of times thereof is also counted. Further, the operation log organization unit 21 similarly organizes the operations to transit outside the screen, such as pressing the back button on the browser or pressing the close button on the browser.

The emotion allocation unit 22 then allocates an emotion to an operation log transmitted by the user (step S3). The emotion storage unit 26 is previously allocated with an emotion and an emotion quotient indicating a magnitude of the emotion for an assumed operation log. The emotion allocation unit 22 allocates an emotion and an emotion quotient to an acquired operation log by use of the data in the emotion storage unit 26. The emotions are anger, expectation, anxiety, and the like, and the emotion quotients such as 100% and 50% are added to the respective emotions. A plurality of emotions may be allocated to one log. For example, when a specific button is repeatedly pressed three times, 100% of anger and 100% of antipathy are allocated thereto.

The emotions are not independent of each other and have certain correlations (see Non-Patent Literature 1). Numerical values indicating the correlations are also previously allocated. When the correlations for anger are of negative: 80%, confusion: 30%, and sadness: 30%, and an emotion for an operation log is 50% of anger, an emotion quotient of sadness for the operation log is assumed as 50%×30%=15%. The correlations of the emotions may be stored in the emotion storage unit 26 or may be stored in other database.

The impact allocation unit 23 then allocates an impact to an operation log transmitted by the user (step S4). The impact storage unit 27 stores impacts on user's emotions of operation logs. For example, an impact of 100% is allocated to an operation of successively pressing a specific button three times. One value of impact is allocated to one operation log and a plurality of impacts are not allocated thereto.

The emotion quotient calculation unit 24 then calculates an emotion quotient in consideration of an impact (step S5). An emotion quotient in consideration of an impact is calculated by a calculation equation of emotion quotient×impact, for example.

The emotion quotient calculation unit 24 then integrates user's emotion quotients by a predetermined unit (step S6). When integrating emotion quotients by the coordinate, the server adds a newly-calculated emotion quotient to the emotion quotients already calculated for a coordinate. A unit to integrate emotion quotients may be screen, screen transition or the like, not limited to coordinate. Further, the emotion quotient calculation unit 24 may further integrate the emotion quotients integrated by the above unit by a predetermined period unit such as by the day of the week or by the hour.

Further, the emotion quotient calculation unit 24 replaces an emotion quotient of an emotion with an emotion quotient of other motion based on predefined numerical values indicating correlations of emotions. When a negative quotient is to be displayed as an emotion quotient after an emotion quotient of anger for an operation log is calculated, for example, the emotion quotient calculation unit 24 calculates the negative quotient by calculating anger quotient×80% based on a correlation of 80% of the anger quotient relative to the negative quotient.

The series of processing in step S2 to step S6 in the server 20 may be performed at a predetermined time such as midnight every day, or may be performed each time an operation log is transmitted.

The display unit 25 displays a user's emotion depending on an emotion quotient in response to a manager's request (step S7). The display unit 25 displays emotion quotients by different colors, for example. For example, the emotion quotient display method may employ display methods such as heat map, process map and timeline.

FIG. 4 is an explanatory diagram illustrating screen display expressing emotion quotients by use of a heat map. The heat map is a display method for displaying user's emotions by different colors. The display unit 25 displays positive in red and negative in blue, for example, by use of a heat map. In FIG. 4, it is assumed that the ovals over the button B1 and the text box T1 are displayed in blue and the oval over the text box T2 is displayed in red. In the example illustrated in FIG. 4, a magnitude of each quotient is indicated by color density. For example, when the negative quotient for the button B1 is 5.20 and the positive quotient therefor is 0.00, the emotion quotient is calculated as 5.20−0.00=5.20. The display unit 25 then displays deep blue corresponding to 5.20 negative over the button B1. Further, when the emotion quotient of the text box T1 is 3.0 negative, the text box T1 is displayed in lighter blue than the color over the button B1. When the emotion quotient of the text box T2 is 2.0 positive, the text box T2 is displayed in light red.

The method for displaying emotion quotients in a heat map is not limited to the above method. The display unit 25 may express emotion quotients in one color, where a darker color expresses negative and a lighter color expresses positive. Alternatively, the display unit 25 may plot a plurality of points thereby to express emotion quotients by density of the points or mixture of the points. Alternatively, the display unit 25 may express emotion quotients by face expressions such as smile and anger by use of face icons or photographs.

Alternatively, the display unit 25 may express emotion quotients in cooperation of UI (User Interface) such as mouse pointer and emotion expressions. For example, the display unit 25 may be such that a face icon is attached to the pointer and an expression thereof is changed depending on a place when the mouse pointer is moved.

FIG. 4 illustrates individual emotion quotients in specific areas (coordinates), but one emotion quotient may be displayed per screen. With such display, the designer can know a user's emotion by the screen.

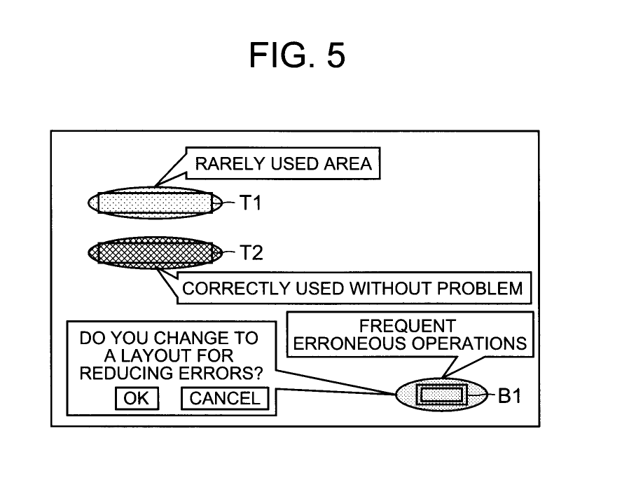

FIG. 5 is an explanatory diagram illustrating screen display displaying evaluation contents and a question about whether to change the screen together with emotion quotients. As illustrated in FIG. 5, if an area with a higher negative quotient is present, for example, the display unit 25 displays evaluation contents indicating why the negative quotient is high in a balloon. Further, the display unit 25 may display evaluation contents on top of the screen together, not limited to the display in balloons. Evaluation contents may be stored in the RAM or hard disk, not displayed on the screen, and the designer may display the evaluation contents as needed.

As illustrated in FIG. 5, for example, if text is rarely input in a text box which is not a mandatory input item, “rarely used area” is displayed. If text is not input in a text box which is a mandatory input item and the screen transition button is pressed, “frequent erroneous operations” is displayed. Further, for example, “correctly used without problem” is displayed for an area with a higher positive quotient than a predetermined value. Evaluation contents corresponding to specific operation contents are previously stored in a database or the like in order to display the evaluation contents.

Further, when the emotion quotient calculation unit 24 determines that the negative quotient is higher than a predetermined value, the display unit 25 displays a question about whether to change the screen, or “Do you change to a layout for reducing errors?” as illustrated in FIG. 5. In this case, when the designer presses “OK”, a screen improvement processing described later is performed.

Evaluation contents corresponding to an emotion quotient are displayed so that the designer can know which problem is in an area with a high negative quotient. Thereby, the designer can easily consider how to improve the operation screen. The display unit 25 displays a question about whether to change the screen together with the above display, and if the screen needs to be improved, the designer can smoothly proceed to the processing of changing the screen.

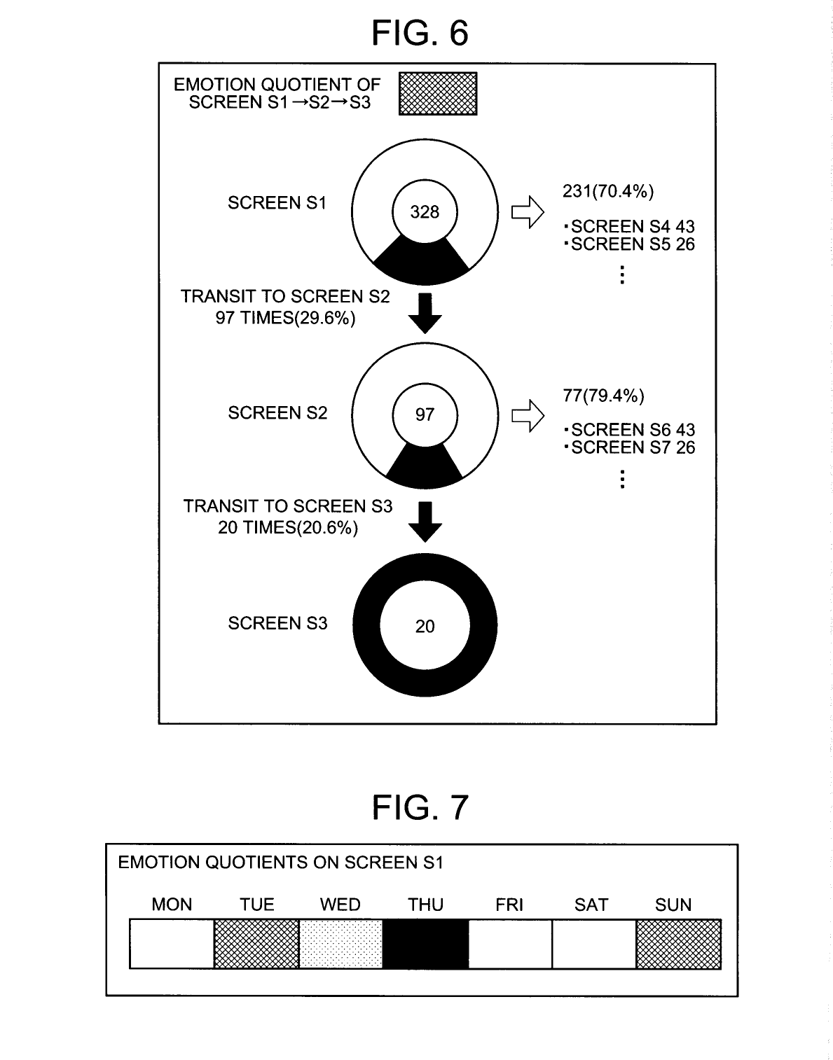

FIG. 6 is an explanatory diagram illustrating screen display displaying a process map together with emotion quotients. An operation log contains information on screen transition or information on how a screen transits. For example, when a series of processing is completed by three screens including screen S1, screen S2 and screen S3, if the screen transits to other screen instead of transiting up to the screen S3 or is closed, the object is not achieved and thus a negative emotion quotient increases.

In the process map illustrated in FIG. 6, the emotion quotient in the transition of screen S1→screen S2→screen S3 is displayed on the top in red for positive and in blue for negative. The example illustrated in FIG. 6 assumes that the emotion quotient in screen S1→screen S2→screen S3 is displayed in blue for negative. Further, transition situations from the screen S1 to the screen S3 are displayed at the bottom. The example illustrated in FIG. 6 demonstrates that the screen S1 is displayed 328 times, and then transits to the screen S2 97 times (29.6%), and then transits to the screen S3 20 times (20.6%). In the example, the emotion quotient is displayed depending on a rate of the number of times when the screen S3 is displayed relative to the number of times when the screen S1 is displayed. The display unit 25 may display an emotion quotient depending on a rate of transition from the screen S1 to the screen S2 and an emotion quotient depending on a rate of transition from the screen S2 to the screen S3, respectively.

When a process map is used for display, or when a series of processing is performed on a plurality of screens, for example, whether screen transition is made smoothly is expressed by use of an emotion quotient. Thus, the designer can grasp a user's emotion for the screen transition.

FIG. 7 is an explanatory diagram illustrating screen display expressing emotion quotients by use of a timeline (time table). The screen illustrated in FIG. 7 specifically displays the colors indicating the emotion quotients in the screen S1 by the day of the week. The display unit 25 may express a magnitude of a quotient by color density expressing negative in blue and positive in red or may express emotion quotients by density of one color similarly to the heat map illustrated in FIG. 4 for the colors expressing emotion quotients. Further, the display unit 25 may express daily emotion quotients by colors on a monthly calendar, for example. Further, the display unit 25 may display emotion quotients by the hour in a day. Further, the display unit 25 may display emotion quotients by the specific coordinate, not by the screen, on a time line.

With the expression by use of a timeline, the designer can easily grasp a change in emotion quotient over time. For example, when an emotion quotient tends to deteriorate or an emotion quotient on a specific day of the week tends to be bad, the designer can easily grasp the trends.

Further, the display unit 25 may display a question about whether to change the screen as illustrated in FIG. 5 together with the process map of FIG. 6 and the timeline of FIG. 7. In this case, the screen improvement processing described later is performed in response to selection of the designer.

The screen improvement unit 28 then acquires emotion quotients of the operation screen from the emotion quotient calculation unit 24 (step S8). The operation screen contains a plurality of blocks and each block contains a plurality of coordinates. The screen improvement unit 28 assumes an average value of emotion quotients at the respective coordinates as an emotion quotient of the block. Further, when a plurality of emotions are present in one block, the screen improvement unit 28 applies an improvement idea corresponding to an emotion with the highest rate in the block.

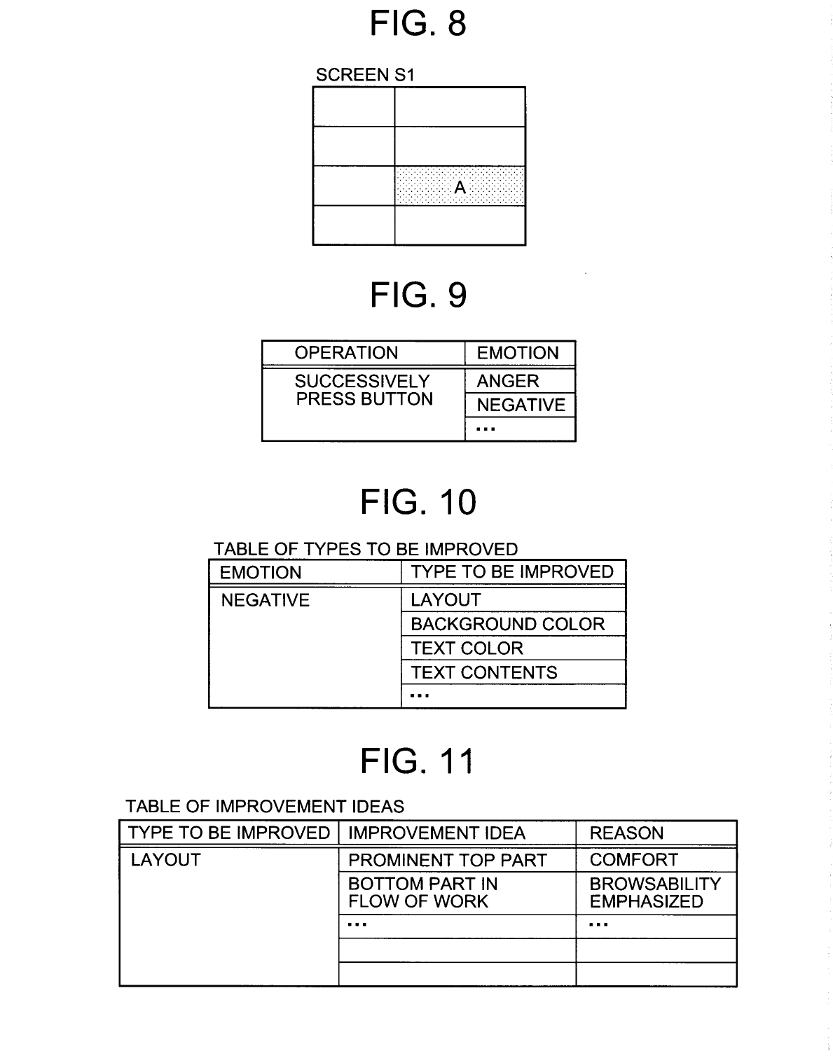

FIG. 8 is an explanatory diagram illustrating an exemplary screen displaying an emotion quotient per block. FIG. 9 is an explanatory diagram illustrating an exemplary table of emotions. The table of emotions illustrated in FIG. 9 is stored in the emotion storage unit 26. For example, assuming that the button is successively pressed in the block A on the screen S1 and the negative emotion has a highest value, the block A is displayed in a color for negative as illustrated in FIG. 8.

If the size of the block A is 200×100, 20000 coordinates are present therein. The screen improvement unit 28 assumes an average value of emotion quotients at all the coordinates as an emotion quotient of the block. For example, assuming total negative quotient of 20000 coordinates=200.00 and total number of views of the screen S1=500, the negative quotient of the block A=200.00÷500=0.40 is assumed. In this way, the average value is calculated by use of the total number of views of the screen S1, not the number of times when a quotient is allocated to the block A.

The screen improvement unit 28 then acquires a type to be improved corresponding to the emotion quotient of the block (step S9). When the designer instructs to change the screen or when an emotion of the block is a negative emotion such as anger and negative and its emotion quotient is higher than a predetermined value, the screen improvement unit 28 acquires a type to be improved corresponding to the emotion by use of the table of types to be improved stored in the improvement idea storage unit 30. Specifically, the screen improvement unit 28 presents the types to be improved from the table of types to be improved stored in the improvement idea storage unit 30, and the designer selects a type to be improved. The display unit 25 is used for the presentation, for example.

FIG. 10 is an explanatory diagram illustrating an exemplary table of types to be improved. In the example illustrated in FIG. 10, the types to be improved including layout, background color, text color and text contents are allocated to the negative emotion. The following example assumes that the designer selects layout as a type to be improved.

The screen improvement unit 28 then acquires an improvement idea corresponding to the selected type to be improved from the table of improvement ideas (step S10). Specifically, the screen improvement unit 28 presents the improvement idea corresponding to the selected type to be improved and the reason why the improvement idea is employed, and acquires the improvement idea selected by the designer. The display unit 25 is used for the presentation, for example.

FIG. 11 is an explanatory diagram illustrating an exemplary table of improvement ideas. The table of improvement ideas is stored in the improvement idea storage unit 30. The table of types to be improved and the table of improvement ideas may be stored in different storage units. When an improvement idea applied in the past is present in the table of improvement ideas, the reason why the improvement idea was employed is recorded therein. The reason is previously defined by the user. The designer selects an improvement idea based on the reason. For example, in the example illustrated in FIG. 11, when wishing to place emphasis on comfort, the designer selects “top part which is prominent” corresponding to comfort emphasized.

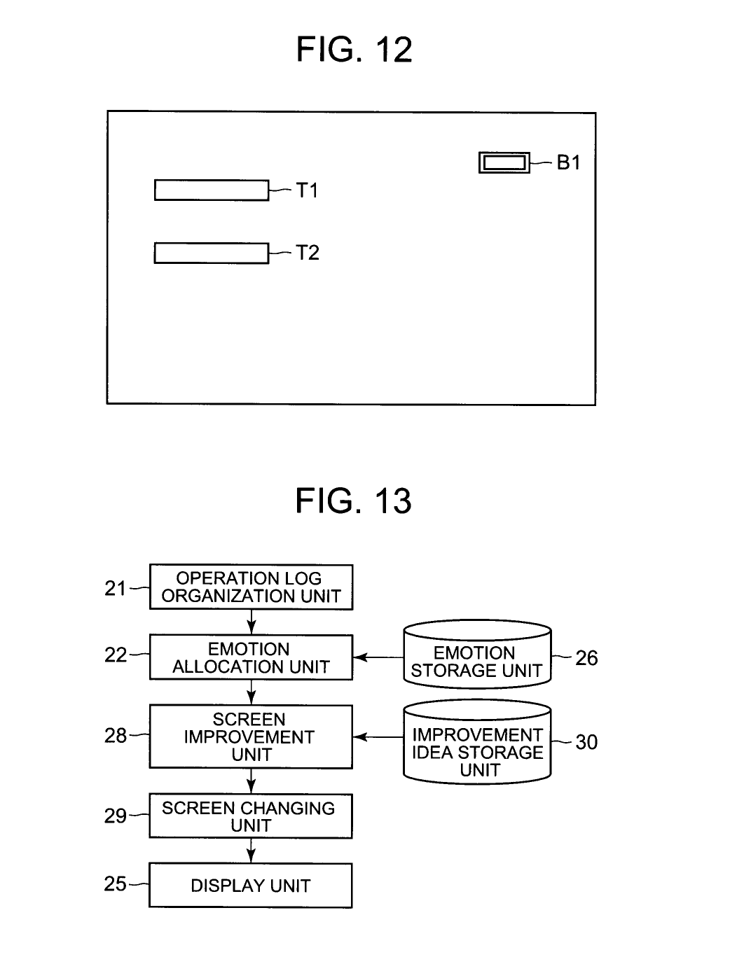

The screen changing unit 29 then changes the operation screen based on the selected improvement idea (step S11). Further, the screen changing unit 29 causes the display unit 25 to display the changed screen. FIG. 12 is an explanatory diagram illustrating an exemplary changed screen. The screen illustrated in FIG. 12 is changed, and thus the button B1 is arranged at an upper position than in the non-improved screen illustrated in FIG. 3.

A plurality of tables of types to be improved and tables of improvement ideas are prepared, and a proper table according to the screen to be improved by the screen improvement unit 28 may be selected. A proper table is created based on the past improvements for the screens similar to the screen for which layout and correlations of quotients of surrounding blocks are to be improved.

Further, the emotions, the types to be improved, the improvement ideas and the reasons stored in the improvement idea storage unit 30 are not limited to the contents illustrated in FIG. 9 to FIG. 11. Further, the improvement idea storage unit 30 may store improvement ideas corresponding to complex emotions such as anger+negative.

Further, the improvement idea storage unit 30 may previously store an improved screen layout created based on the improvement ideas. In this case, the designer can select an improvement idea with reference to the improved screen layout.

### EXAMPLES

Part of the operations of the screen changing device according to the present exemplary embodiment will be described below by use of specific numerical values by way of example. Specific numerical values for calculations especially in the emotion allocation unit 22, the impact allocation unit 23, and the emotion quotient calculation unit 24 will be described below by way of example.

The emotion storage unit 26 used by the emotion allocation unit 22 is allocated with emotions and emotion quotients for operation logs as follows, for example.
(1) Input in text box or press button: No emotion=0%
(2) Input in text box, then press button: 50% of expectation, 100% of acceptance
(3) Repeatedly press button three times: 100% of anger, 100% of antipathy
(4) No operation: 30% of anxiety

The impact storage unit 27 used by the impact allocation unit 23 is allocated with impacts on emotions for operation logs as follows, for example. The operation logs stored in the impact storage unit 27 are further subdivided than the operation logs stored in the emotion storage unit 26 as described later according to the present exemplary embodiment.
(1) Input in text box T1 or press button B1: Impact=10%
(2) Input in text box T1, then press button B1: Impact=10%
(3) Repeatedly press button B1 three times: Impact=100%
(4) No operation: Impact=50%

The emotion quotient calculation unit 24 calculates emotion quotient×impact as follows thereby to calculate an emotion quotient in consideration of an impact.
(1) Input in text box T1, press button B1: 0%×10%=0
(2) Input in text box T1, then press button B1: 50%×10%=expectation of 0.05, 100×10%=acceptance of 0.1
(3) Repeatedly press button B1 three times: Anger=100%×100%=1
(4) No operation: 30%×50%=anxiety of 0.15

The previously-calculated emotion quotients are assumed to be recorded as follows.
(1) Input in text box T1, press button B1: 0
(2) Input in text box T1, then press button B1: Expectation quotient of 1, acceptance quotient of 2
(3) Repeatedly press button B1 three times: Anger quotient of 5.50
(4) No operation: Anxiety quotient of 1.5

In such a case, the emotion quotient calculation unit 24 adds a newly-calculated emotion quotient to the emotion quotients previously calculated for a coordinate. According to the present exemplary embodiment, the respective emotion quotients are calculated as follows. (1) Input in text box T1, press button B1: 0+0=0
(2) Input in text box T1, then press button B1: Expectation quotient of 1+0.05=1.05, acceptance quotient of 2+0.1=2.1
(3) Repeatedly press button B1 three times: Anger quotient of 5.50+1=6.50
(4) No operation: Anxiety quotient of 1.5+0.15=1.65

The emotion quotient calculation unit 24 then replaces a calculated emotion quotient with other emotion quotient by use of the correlations of emotions. In the present exemplary embodiment, a positive quotient and a negative quotient are calculated as emotion quotients. A correlation of each of the quotients relative to the positive quotient or the negative quotient is assumed to be defined as follows, for example.
(1) Correlation of expectation quotient relative to positive quotient: 60%
(2) Correlation of acceptance quotient relative to positive quotient: 80%
(3) Correlation of anger quotient relative to negative quotient: 80%
(4) Correlation of anxiety quotient relative to negative quotient: 60%

In this case, a positive quotient or a negative quotient for each operation is calculated as follows.
(1) Input in text box T1, press button B1: 0
(2) Input in text box T1, then press button B1: 1.05×60% +2.1×80%=0.63+1.68=positive quotient of 2.31
(3) Repeatedly press button B1 three times: 6.50×80%=negative quotient of 5.2
(4) No operation: 1.65×60%=negative quotient of 0.99

When requested by the manager, the display unit 25 displays a user's emotion according to an emotion quotient. The display unit 25 displays the negative quotient by use of the heat map illustrated in FIG. 4, for example. When the emotion quotient calculation unit 24 determines that the negative quotient is higher than 5.0, the display unit 25 displays a question about whether to change the screen, or “Do you change to a layout for reducing errors?” as illustrated in FIG. 5.

The screen improvement unit 28 then acquires an emotion quotient of the operation screen from the emotion quotient calculation unit 24. The screen improvement unit 28 assumes an average value of emotion quotients at the respective coordinates as an emotion quotient of the block.

Then, when the designer instructs to change the screen, or when an emotion of the block is a negative emotion such as anger and negative and its emotion quotient is higher than 5.0, the screen improvement unit 28 acquires a type to be improved corresponding to the emotion by use of the table of types to be improved stored in the improvement idea storage unit 30. The button B1 has a negative quotient of 5.2 as described above, and thus the screen improvement unit 28 acquires a type to be improved corresponding to the emotion. The present exemplary embodiment assumes that the designer selects layout as a type to be improved from among the types to be improved illustrated in FIG. 10.

The screen improvement unit 28 then acquires an improvement idea corresponding to the selected type to be improved from the table of improvement ideas. Specifically, the screen improvement unit 28 presents the improvement idea corresponding to the selected type to be improved and the reason why the improvement idea is employed, and acquires the improvement idea selected by the designer. The present exemplary embodiment assumes that the designer selects “prominent top part” corresponding to comfort emphasized.

The screen changing unit 29 then changes the operation screen based on the selected improvement idea. According to the present exemplary embodiment, as illustrated in FIG. 12, the screen is changed so that the button B1 is arranged at an upper position than in the non-improved screen illustrated in FIG. 3.

The screen changing device according to the present exemplary embodiment quantitatively expresses user's comfort by use of emotion quotient values. Therefore, the designer can easily know user's comfort for the operation screen, thereby easily finding an item to be preferentially corrected and changing the screen.

With the screen changing device according to the present exemplary embodiment, the designer recognizes user's emotions thereby to grasp an optimum UI design principle. The designer can know where the user often dithers or where the user often makes mistakes, for example, thereby grasping potential UI design problems which cannot be found by tests or interviews. Further, the designer can analyze marketing in system use which cannot be known by the UI experts, thereby grasping an optimum UI design principle. Specifically, the user can analyze not only majority and minority of user groups but also marketing in system use for innovators and early adopters.

With the screen changing device according to the present exemplary embodiment, the user can recognize a comfortable system use method. For example, the screen changing device according to the present exemplary embodiment can detect unusual operations or perceptions such as human errors, and can support individual users. Further, the user can customize to a comfortable system by him/herself by the screen changing device according to the present exemplary embodiment. Further, the results lead to supports for other users.

Property data extracted by the screen changing device according to the present exemplary embodiment can be applied as UX (user experience) big data.

FIG. 13 is a block diagram illustrating a structure of essential parts in a screen changing device according to the present invention. As illustrated in FIG. 13, the screen changing device according to the present invention includes, as main components, the operation log organization unit 21 for classifying operation logs containing operation contents on operation screens, by type of operation contents; the emotion storage unit 26 for storing user's emotions and emotion quotients indicating magnitudes of the emotions corresponding to the operation logs; the emotion allocation unit 22 for allocating the user's emotions and the emotion quotients stored in the emotion storage unit 26 to the organized operation logs; the display unit 25 for displaying the information on the user's emotions and the emotion quotients allocated to the operation logs; the improvement idea storage unit 30 for storing improvement ideas of the operation screens corresponding to user's emotions; the screen improvement unit 28 for acquiring the improvement ideas of the operation screens corresponding to the user's emotions allocated to the operation logs from the improvement idea storage unit 30 and presenting the same on the display unit; and the screen changing unit 29 for changing the operation screen based on an improvement idea selected by a designer from among the presented improvement ideas.

The following screen changing devices described in (1) to (5) are also disclosed in the above exemplary embodiment.
(1) The screen changing device, wherein the improvement idea storage unit stores a plurality of types to be improved corresponding to user's emotions and a plurality of improvement ideas corresponding to the types to be improved, and the screen improvement unit acquires the types to be improved corresponding to user's emotions allocated to operation logs from the improvement idea storage unit and presents the same on the display unit, and acquires an improvement idea corresponding to a type to be improved selected by a designer from the improvement idea storage unit and presents the same on the display unit.
(2) The screen changing device may be configured such that the improvement idea storage unit stores a reason why an improvement idea is employed corresponding to the improvement idea of the operation screen, and the screen improvement unit presents the improvement idea with the reason on the display unit. With the screen changing device, the functions or operability of the operation screen emphasized by the designer can be improved.
(3) The screen changing device may be configured to include: an impact storage unit (the impact storage unit 27, for example) for storing impacts on emotions of operation logs; an impact allocation unit (the impact allocation unit 23, for example) for allocating the impacts to the operation logs; and an emotion quotient calculation unit (the emotion quotient calculation unit 24, for example) for calculating emotion quotients in consideration of impacts based on emotion quotients and the impacts. With the emotion visualization device, emotion quotients can be calculated at a higher accuracy in consideration of impacts.
(4) The screen changing device may be configured such that the emotion quotient calculation unit replaces an emotion quotient of an emotion with an emotion quotient of other emotion based on predefined numerical values indicating correlations of emotions. With the emotion visualization device, an emotion quotient desired by the designer can be displayed.
(5) The screen changing device may be configured such that the display unit (the display unit 25, for example) expresses user's emotions and emotion quotients by different colors. With the emotion visualization device, the designer can easily know user's comfort.

The present application claims the priority based on Japanese Patent Application No. 2013-008110 filed on Jan. 21, 2013, the disclosure of which is entirely incorporated herein by reference.

The present invention has been described with reference to the exemplary embodiment and examples, but the present invention is not limited to the exemplary embodiment and examples. A structure and details of the present invention may be variously changed within the scope of the present invention understandable by those skilled in the art.

### INDUSTRIAL APPLICABILITY

The present invention can be applied to design a system operation screen.

### REFERENCE SIGNS LIST

10 Client terminal
20 Server
21 Operation log organization unit
22 Emotion allocation unit
23 Impact allocation unit
24 Emotion quotient calculation unit
25 Display unit
26 Emotion storage unit
27 Impact storage unit
28 Screen improvement unit
29 Screen changing unit
30 Improvement idea storage unit

What is claimed is:

1. A screen changing device comprising:
an operation log organization unit for organizing operation logs containing operation contents on operation screens by type;
an emotion storage unit for storing user's emotions and emotion quotients indicating magnitudes of the emotions corresponding to the operation logs;
an emotion allocation unit for allocating the user's emotions and the emotion quotients stored in the emotion storage unit to the organized operation logs;
a display unit for displaying the information on the user's emotions and the emotion quotients allocated to the operation logs;
an improvement idea storage unit for storing improvement ideas of the operation screens corresponding to user's emotions;
a screen improvement unit for acquiring the improvement ideas of the operation screens corresponding to the user's emotions allocated to the operation logs from the improvement idea storage unit and presenting the same on the display unit; and
a screen changing unit for changing the operation screen based on an improvement idea selected by a designer from among the presented improvement ideas.

2. The screen changing device according to claim 1,
wherein the improvement idea storage unit stores a plurality of types to be improved corresponding to user's emotions and a plurality of improvement ideas corresponding to the types to be improved, and
the screen improvement unit acquires the types to be improved corresponding to user's emotions allocated to operation logs from the improvement idea storage unit and presents the same on the display unit, and acquires an improvement idea corresponding to a type to be improved selected by a designer from the improvement idea storage unit and presents the same on the display unit.

3. The screen changing device according to to claim 1,
wherein the improvement idea storage unit stores a reason why an improvement idea is employed corresponding to the improvement idea of the operation screen, and
the screen improvement unit presents the improvement idea with the reason on the display unit.

4. The screen changing device according to claim 1, comprising:
an impact storage unit for storing impacts on emotions of operation logs;
an impact allocation unit for allocating the impacts to the operation logs; and
an emotion quotient calculation unit for calculating emotion quotients in consideration of impacts based on the emotion quotients and the impacts.

5. The screen changing device according to claim 4,
wherein the emotion quotient calculation unit replaces an emotion quotient of an emotion with an emotion quotient of other emotion based on predefined numerical values indicating correlations of emotions.

6. The screen changing device according to claim 1,
wherein the display unit expresses user's emotions and emotion quotients by different colors.

7. A screen changing method comprising the steps of:
organizing operation logs containing operation contents on operation screens by type;
storing user's emotions and emotion quotients indicating magnitudes of the emotions corresponding to the operation logs;
allocating the stored user's emotions and emotion quotients to the organized operation logs;
displaying the information on the user's emotions and the emotion quotients allocated to the operation logs;
storing improvement ideas of the operation screens corresponding to user's emotions;
acquiring and presenting the stored improvement ideas of the operation screens corresponding to the user's emotions allocated to the operation logs; and
changing the operation screen based on an improvement idea selected by a designer from among the presented improvement ideas.

8. A non-transitory computer readable information recording medium storing a screen changing program that, when executed by a processor, performs a method for
organizing operation logs containing operation contents on operation screens by type;
storing user's emotions and emotion quotients indicating magnitudes of the emotions corresponding to the operation logs;
allocating the stored user's emotions and the emotion quotients to the organized operation logs;
displaying the information on the user's emotions and the emotion quotients allocated to the operation logs;
storing improvement ideas of the operation screens corresponding to user's emotions;
acquiring and presenting the stored improvement ideas of the operation screens corresponding to the user's emotions allocated to the operation logs; and
changing the operation screen based on an improvement idea selected by a designer from among the presented improvement ideas.

9. The screen changing device according to claim 2,
wherein the improvement idea storage unit stores a reason why an improvement idea is employed corresponding to the improvement idea of the operation screen, and
the screen improvement unit presents the improvement idea with the reason on the display unit.

10. The screen changing device according to claim 2, comprising:
an impact storage unit for storing impacts on emotions of operation logs;
an impact allocation unit for allocating the impacts to the operation logs; and
an emotion quotient calculation unit for calculating emotion quotients in consideration of impacts based on the emotion quotients and the impacts.

11. The screen changing device according to claim 3, comprising:
an impact storage unit for storing impacts on emotions of operation logs;
an impact allocation unit for allocating the impacts to the operation logs; and
an emotion quotient calculation unit for calculating emotion quotients in consideration of impacts based on the emotion quotients and the impacts.

12. The screen changing device according to claim 2,
wherein the display unit expresses user's emotions and emotion quotients by different colors.

13. The screen changing device according to claim 3,
wherein the display unit expresses user's emotions and emotion quotients by different colors.

14. The screen changing device according to claim 4,
wherein the display unit expresses user's emotions and emotion quotients by different colors.

15. The screen changing device according to claim 5,
wherein the display unit expresses user's emotions and emotion quotients by different colors.
